(19) United States
(12) Patent Application Publication
(10) Pub. No.: US 2008/0201592 A1
(43) Pub. Date: Aug. 21, 2008

(54) Hibernating a processing apparatus for processing secure data

(75) Inventors: Bryan David Lawrence, Northampton (GB); Neil Edward Parris, Sheffield (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 12/010,891

(22) Filed: Jan. 30, 2008

(30) Foreign Application Priority Data
Feb. 19, 2007 (GB) 0703178.4

(51) Int. Cl. G06F 1/32

(52) U.S. Cl. 713/323

(57) ABSTRACT

A data processing apparatus for processing secure data is disclosed. The data processing apparatus comprising: processing circuitry comprising a plurality of state retention cells in the form of scan chains for holding a current state of said processing circuitry, at least some of the state retention cells being arranged in series; encryption circuitry; and a hibernate signal input; said data processing apparatus being responsive to receipt of a hibernate signal at said hibernate signal input to switch from an operational mode in which said data processing apparatus is powered up, to a low power mode in which at least said processing circuitry is powered down, said data processing apparatus being operable prior to powering down said processing circuitry, to output a state of said processing circuitry from said plurality of state retention cells and to encrypt said output state using said encryption circuitry and to save said encrypted state to said storage device.

### BACKGROUND OF THE INVENTION

1. Field of the Invention

This invention relates to the field of data processing systems. More particularly, this invention relates to the field of hibernation of a processing apparatus for processing secure data.

2. Description of the Prior Art

It is known for systems, particularly those that run on batteries, to conserve power by automatically entering a low power mode or hibernating in response to certain conditions, such as a user not having performed any operations for a predetermined time, or a battery reaching a particular low power state. On doing this the state of the processor will need to be saved in order to allow the processor to resume the same state when it is powered up again. The state needs to be saved somewhere where it will be conserved and as such where the processor is within a chip, it may well leave that chip, as the chip may be powered down. Where the processor is processing secure data, the data leaving the chip in this manner could be a potential security risk.

It is known in some systems to use software to encrypt the state of a CPU before saving it when a user indicates that he wishes the CPU to enter a low power mode, see for example EncryptSwapAnd Root—suspend 2 Wikipedia. This enables the state of the CPU that might have contained sensitive information to be protected from untrusted access. This is done by software in response to a user powering down the CPU.

Furthermore, it is known for processors to have scan chains for testing the processor. These can be used so that an arbitrary pattern can be entered into the chain of flips flops, and/or the state of every flip flop can be read out. This can also be a potential source of leakage of secure data in secure systems such as smart cards. This is discussed in Nwophasis Archives ISN—˜0087—“Scan design called portal for hackers” where it is suggested that decoding logic could be put at an input to a scan chain and encoding logic at an output. Provided the encoding and decoding logic were different it would ensure that you could not scan out what you scanned in. This would provide increased security.

It would be desirable to increase the security of a system that processes secure data and enters a low power or hibernation state.

### SUMMARY OF THE INVENTION

A first aspect of the present invention provides a data processing apparatus for processing secure data, said data processing apparatus comprising: processing circuitry comprising a plurality of state retention cells for holding a current state of said processing circuitry, at least some of state retention cells being arranged in series; encryption circuitry; and a hibernate signal input; said data processing apparatus being responsive to receipt of a hibernate signal at said hibernate signal input to switch from an operational mode in which said data processing apparatus is powered up, to a low power mode in which at least said processing circuitry is powered down, said data processing apparatus being operable prior to powering down said processing circuitry, to output a state of said processing circuitry from said plurality of state retention cells and to encrypt said output state using said encryption circuitry and to save said encrypted state to said storage device.

Data processing apparatus operable to power down in response of receipt of a hibernate signal need to store state before powering down. The storage of this state may be a security risk, particularly if it is stored in a place that can be accessed by other processors. Thus, it would be advantageous to encrypt this data. However, any encryption that is done during a switch to hibernation needs to be done in a quick and efficient manner, otherwise the power savings made by switching to this mode may be offset. In effect, given that hibernation is a power saving technique, it would clearly not be advantageous to perform a lot of processing when switching to this state. The present invention takes advantage of state retention cells which hold a current state of the processing circuitry to retrieve that state in, an at least partially, serial manner. Thus, not only is this a convenient way of deriving the entire state of the processing circuitry that is transparent to the user, it also produces the state of the circuitry in the form of one or more serial data streams. This makes it efficient to encrypt using hardware encryption mechanisms. Thus, the encryption of the state of the machine can be done in a quick and power efficient manner while the state is being saved.

In some embodiments said plurality of state retention cells are arranged in series and comprise a scan chain.

Processing circuitry often comprises scan chains and these can be used to output the state of the machine. They may be a single scan chain in which case the state of the processing circuitry is output as a single data stream or they may be multiple scan chains in which case parallel data streams are produced. In either case, the state can be retrieved in response to a simple command, and can be encrypted in an efficient way.

In some embodiments said data processing apparatus comprises said storage device and said storage device is operable to retain data during said low power mode. In other embodiments, the storage device is outside of the data processing apparatus.

If the storage device is within the data processing apparatus then the state is saved within the data processing apparatus. If it is outside of the data processing apparatus then there are particular security issues associated with this and it is particularly advantageous to encrypt the state of the processing circuitry in such circumstances.

In some embodiments said data processing apparatus is formed on a chip.

The present invention is particularly applicable to data processing apparatus formed on a chip. In such a case, the encryption of the state can be performed within the chip and as such this makes it robust to potential hacking attacks.

The processing circuitry can be a number of things in some embodiments it is central processing unit.

In some embodiments the data processing apparatus comprises further processing circuitry such as a co-processor or further central processing unit.

In some embodiments, said circuit further comprises hibernate state control logic, said hibernate state control logic being operable in response to receipt of said hibernate signal at said hibernate signal input to initiate output and encryption of said state of said data processing apparatus and to control storage of said encrypted state.

Control of the switch to hibernation can be performed by hibernate state control logic. In such a case, this logic also controls the encryption of the state and the storage of this encrypted state.

In some embodiments, said data processing apparatus further comprises a non-volatile data store, said hibernate state control logic being further operable to control said encryption logic to generate an encryption key during said operational mode, and to control said data processing apparatus to store said encryption key in said non-volatile data store.

It is advantageous to store an encryption key in a non-volatile data store within the data processing apparatus. This enables it to be retained and also makes it hard to access. It is further advantageous to generate this encryption key during operational mode. By continually generating the key the robustness of security is increased.

In other embodiments, said data processing apparatus further comprises a non-volatile data store, said non-volatile data store storing an encryption key for use by said encryption logic.

It may be that there is no encryption key generation logic and that each data processing apparatus comes with its own key stored within the non-volatile data store. This avoids the need to generate a key but may make it less robust to hacking.

In some embodiments said data processing apparatus further comprises a wake signal input and decryption circuitry, said data processing apparatus being responsive to receipt of a wake signal at said wake signal input to switch from said low power mode to said operational mode, said decryption circuitry being operable to decrypt said stored state and to restore said state to said processing circuit.

On waking the encrypted state needs to be decrypted before it can be restored.

In some embodiments the encryption and decryption circuitry can be separate units while in others they are a single hardware device.

In some embodiments, said data processing apparatus further comprises checking logic, said checking logic being operable to derive a checking value from said state, said encryption logic being operable to encrypt said checking value, said checking value being stored in said storage device with said encrypted state.

In order to check that the state has been successfully stored and that it has not been tampered with by a potential hacker, checking logic can be used that can calculate a checking value and store this checking value. This can be performed on the unencrypted state and the checking value can be encrypted along with the state and stored with it. Alternatively, it can be performed on the encrypted state whereupon the checking value should be stored separately to the encrypted state. In either case, the provision of checking logic helps determine if a hacker has tampered with the state. If this is the case the data processing apparatus can be reset rather than restored on wakeup.

In some embodiments, said decryption circuitry is operable to determine an integrity of said decrypted state from said checking value.

On decryption the decryption logic can determine and calculate a predicted checking value and if it is different to the saved one, then it knows that the state may have been tampered with and the state of the processor is reset and not restored.

In some embodiments, said data processing apparatus is operable to generate said hibernate signal in response to detection of a predetermined condition.

Although the hibernate signal can be generated in a number of ways, it can be generated automatically. Embodiments of the present invention are particularly applicable to the automatic generation of a hibernate signal as owing to the fact that the encryption is performed in hardware, it can be performed quickly and efficiently in response to automatic signals.

A further aspect of the present invention provides a method of securely saving a state of a processor during hibernation, comprising the steps of: processing secure data using processing circuitry comprising a plurality of state retention cells for holding a current state of said processing circuitry, at least some of state retention cells being arranged in series; receiving a hibernate signal at a hibernate signal input; in response to said hibernate signal switching from an operational mode in which said data processing apparatus is powered up, to a low power mode in which at least said processing circuitry is powered down by: outputting a state of said processing circuitry from said state retention cells; encrypting said output state using encryption circuitry; saving said encrypted state to a storage device; and powering down said processing circuitry.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically shows a data processing apparatus according to an embodiment of the present invention;

FIG. 2 shows an embodiment of the invention applied to a Trustzone system;

FIG. 3a shows the steps performed when hibernating according to an embodiment of the present invention; and

FIG. 3b shows the steps performed when waking a hibernated system according to an embodiment of the present invention.

### DESCRIPTION OF THE PREFERRED EMBODIMENTS

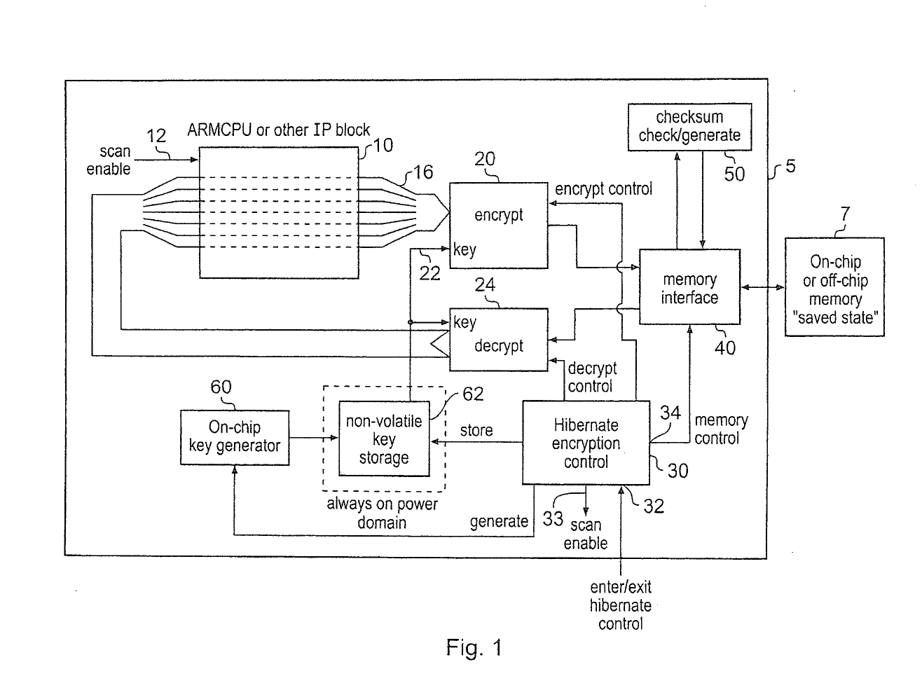

FIG. 1 shows a data processing chip 5 according to an embodiment of the present invention and an off chip memory store 7 for storing a saved state of the processing chip when it enters a hibernate mode. Data processing chip 5 comprises a CPU 10 having a scan enable input 12 and scan chains 16. Although in this embodiment a CPU is shown, it will be clear to a skilled person that embodiments of the invention could be applicable to other processing blocks. The scan chains 16 have inputs and outputs which are respectively connected to encryption circuitry 20 and decryption circuitry 24. Although in this embodiment, these are shown as separate circuitry, it will be clear to the skilled person that this could be a single cryptography block.

In addition to this, data processing chip 5 comprises hibernate encryption control logic 30 operable to control the encryption of the CPU state at hibernation prior to it being saved off chip. Processing chip 5 also comprises a memory interface 40 for controlling the storage and a check sum logic 50. Processing chip 5 also comprises an on chip key generator 60 and a non-volatile key storage area 62. The non-volatile key storage unit 62 is in an always on power domain, such that during hibernation this information is not lost.

Hibernate encryption control logic 30 has an input 32 for receiving a hibernate or a wake signal. In response to receipt of a hibernate signal at input 32 hibernate encryption control logic 30 is operable to send a scan enable signal from output 33 to scan enable input 12 of CPU 10. This activates the scan chain 16 and means that the state of CPU 10 can then be scanned out via the scan chain 16. In this embodiment, a number of scan chains 16 are shown in parallel to each other. It would be clear to a skilled person that there could be a single scan chain or there could be multiple scan chains. Scan chains act as a serial shift register and in effect serially shift the data containing state of the CPU 10 out of it. Having a number of scan chains in parallel reduces the time taken to shift out this information. This output data is then sent to encryption logic 20 which acts to encrypt the state. The nature of the scan chains means that the data output is output as one or several serial data streams. This is convenient as serial data streams are particularly suitable for hardware encryption, encryption logic finding it easier to encrypt serial streams of data than to encrypt a whole mass of data arriving in parallel. Encryption logic 20 has a further input 22 at which the encryption key is entered. Encryption key is stored in non-volatile key storage 62. In this embodiment, the encryption key is generated from an on chip key generator 60. Thus, during the functional mode of operation of the processing chip 5, this on chip key generator acts to generate a key and stores this key on non-volatile storage 62. Generating new keys during operation of the chip provides for robust security. An alternative would be to have an encryption key permanently stored in non-volatile key storage 62. This encryption key would be stored in the key storage at manufacture of the chip 5 and would be unique to that particular chip or would be a fixed key for a number of chips. This would avoid the need to have an on chip key generator 60, but would not provide as robust security as the continual generation of new keys does.

The encrypted state is then stored on the off chip memory 7 under a control of memory interface 40. Prior to storing it off chip, a checksum could be performed using checksum generator 50. A checksum is a form of redundancy check, a very simple measure for protecting the integrity of data by detecting errors in data. It works by adding up the basic components of the data, and storing the resulting value. Later, anyone can perform the same operation on the data, compare the result to the authentic checksum, and (assuming that the sums match) conclude that the data has probably not been corrupted. The checksum could be performed on the data prior to encryption and then the check value could be encrypted and saved with the data. Alternatively, a checksum could be performed on the encrypted data as is shown, in this case the checksum value is not itself encrypted and should therefore be stored at a different place to the encrypted data.

Although a checksum is shown in this embodiment as being performed on the data to verify it, it would be clear to the skilled person that different calculations could be performed on the data to produce a result that could be used to verify the data. For example, a hash function could be performed on the encrypted data and its value stored. A hash function takes a long string of data of any length as input and produces a fixed length string as output. It is sometimes termed a digital fingerprint. The function is a one way function and as such no information regarding the data can be gained from the hash. Performing the function on the data again should produce the same result, if it does not then this is an indication that the data has been tampered with. As the hash function gives no information regarding the data it can be stored alongside it.

Although in this embodiment, the memory for saving state is shown as being off chip, it should be clear to a skilled person that it could be on chip. However, embodiments of the present invention are particularly applicable to off chip memory storage as it is here that security issues are particularly relevant.

Once this information has been stored, the processing chip 5 can then enter hibernation mode wherein a part of the chip is powered down. This would include the CPU 10 and may include many other portions of the chip. It would not include the non-volatile key storage unit 62 which is required to keep power as this key is needed to restore the state of the CPU. It should be noted that this non-volatile data store may be a memory in a portion of the chip that is always powered up during hibernate, or it may be a memory that can retain state even without power such as a flash, or if the key is one that is set at manufacture rather than being one that is generated during operation the key may be hard wired into the system.

It should be noted that the use of scan chains to output the state of the processor is not only desirable due to their serial nature, but is also desirable as in response to a single signal the state can simply be automatically retained and then output. It should also be noted, that the hibernate signal at the hibernate signal input 32 can come from a user, but it can also be automatically generated in response to predetermined conditions. These may be no input from a user over a predetermined time, or they may be the power of the battery falling below a certain value or they may be any number of predetermined conditions.

When it is desired to wake the CPU from its hibernation state, a wake signal is input at input 32, the whole chip is powered up and hibernation control logic 30 then acts to control the processing chip 5 to restore its state. Thus, a signal is sent via output 34 through the memory interface 40 and the saved encrypted state is then directed via memory interface 40 to decryption circuitry 24. This is controlled by hibernate control logic and a key is sent from the non-volatile key storage 62 to the decryption logic. The decryption logic can then decrypt the streams of encrypted data and these can be sent via the scan chains to restore the state of CPU 10. Once the CPU is restored then it can continue processing.

When decrypting the data via decryption logic 24 a check can also be made if a checksum or hash generation was performed to check that the state has not been tampered with. If the state has been tampered with then it is not restored and the CPU is reset.

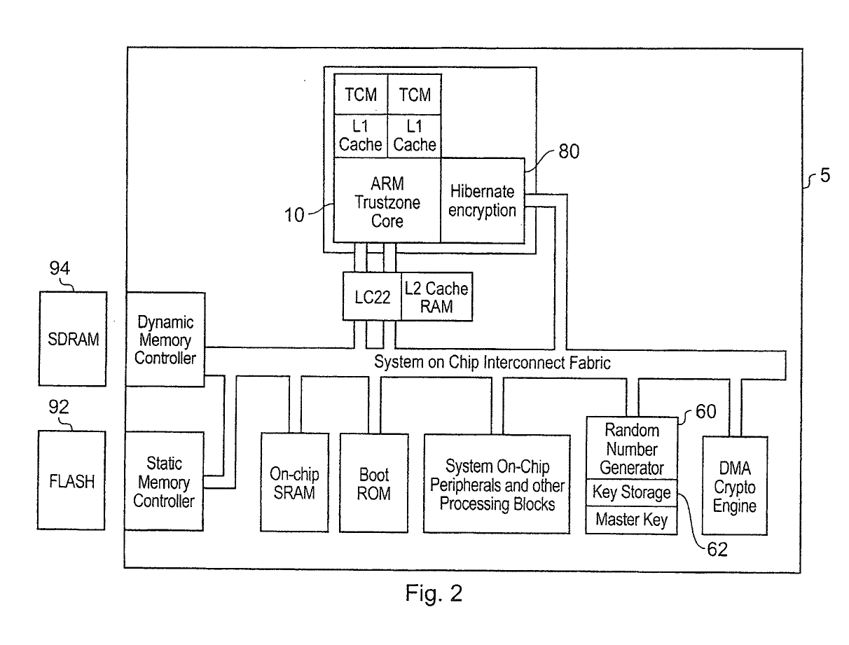

FIG. 2 shows a data processing apparatus 5 having an ARM® Trustzone core with hibernation encryption tightly coupled to it. An ARM Trustzone core is an ARM secure system operable to process secure data and protect the secure data for non-secure processes. Details of the ARM Trustzone system can be found in example in commonly assigned co-pending U.S. patent application Ser. No. 10/714,561. The data processing apparatus 5, has a secure Trustzone processing core 10 with hibernate encryption logic 80 tightly coupled to it. It also has buses, memory controllers, other peripherals, a random number generator 60, which can be used to generate the encryption keys and a non-volatile key storage area 62 for storing the encryption and decryption keys. There is also external memory comprising flash memory 92 and SDRAM 94. The encrypted state of core 10 can be stored in SDRAM 94 during hibernation. Although not explicitly shown, core 10 has scan chains for retaining and scanning out the state of the processor. On hibernation this state is scanned out to hibernate encryption logic 80 where it is encrypted prior to being stored.

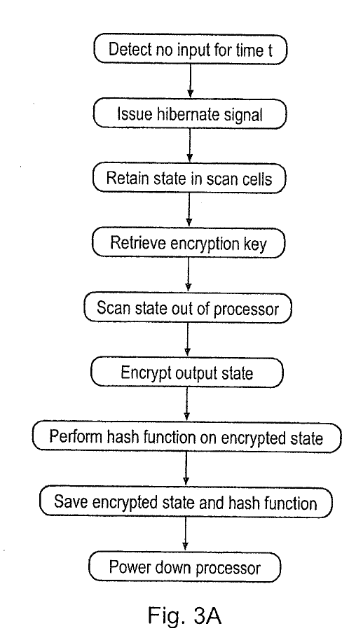

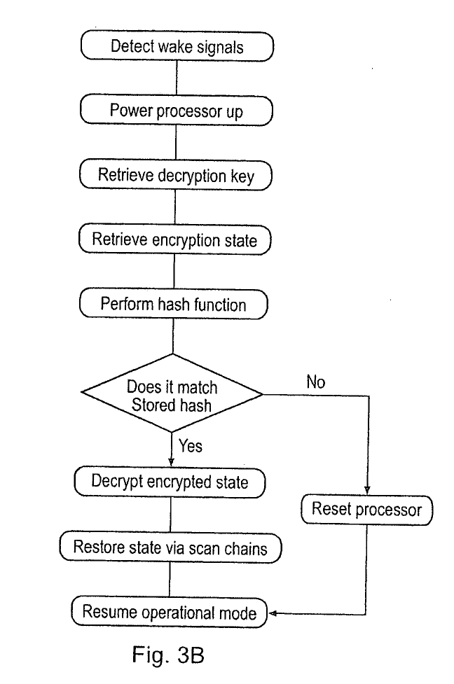

FIG. 3a shows a flow diagram illustrating the steps in a method of hibernating a secure core according to an embodiment of the present invention. In this system when no input has been detected for a predetermined amount of time t, a hibernate signal is generated and issued to hibernate control logic. The state in the scan cells is then retained and the encryption key retrieved. The retained state is then scanned out of the processor and this output state is then encrypted. A hash function is then performed on the encrypted state and the encrypted state and calculated hash value are saved in a non-volatile memory. The processor can then be powered down.

FIG. 3b shows a flow diagram illustrating the steps in a method of waking a hibernated secure core according to an embodiment of the present invention. Initially a wake signal is detected, and in response to this the processor is powered up. The decryption key is then retrieved. The encrypted state and hash value are then retrieved from a non-volatile memory store and a hash function performed on it. If the calculated hash value matches the retrieved one, then the data is probably not corrupt and the encrypted state is decrypted and restored via the scan chains to the processor. Operational mode can then be resumed.

If the hash value is not the same as the stored hash then the data has probably been tampered with and thus, it is not decrypted and the state of the processor is not restored. Rather the processor is reset and the encrypted stored state thrown away.

Embodiments of the invention are applicable to secure systems as if there is no secure data then there is no reason to encrypt the state.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A data processing apparatus for processing secure data, said data processing apparatus comprising:
processing circuitry comprising a plurality of state retention cells for holding a current state of said processing circuitry, at least some of said state retention cells being arranged in series;
encryption circuitry; and
a hibernate signal input;
said data processing apparatus being responsive to receipt of a hibernate signal at said hibernate signal input to switch from an operational mode in which said data processing apparatus is powered up, to a low power mode in which at least said processing circuitry is powered down, said data processing apparatus being operable prior to powering down said processing circuitry, to output a state of said processing circuitry from said plurality of state retention cells and to encrypt said output state using said encryption circuitry and to save said encrypted state to said storage device.

2. A data processing apparatus according to claim 1, wherein said plurality of state retention cells are arranged in series and comprise a scan chain.

3. A data processing apparatus according to claim 1, wherein said plurality of state retention cells comprise multiple scan chains arranged in parallel with each other.

4. A data processing apparatus according to claim 1, wherein said data processing apparatus comprises said storage device and said storage device is operable to retain data during said low power mode.

5. A data processing apparatus according to claim 1, wherein said data processing apparatus is formed on a chip.

6. A data processing apparatus according to claim 1, wherein said processing circuitry is a central processing unit.

7. A data processing apparatus according to claim 1, said data processing apparatus further comprising further processing circuitry, said further processing circuitry comprising at least one of a co-processor and a central processing unit.

8. A data processing apparatus according to claim 1, said circuit further comprising hibernate state control logic, said hibernate state control logic being operable in response to receipt of said hibernate signal at said hibernate signal input to initiate output and encryption of said state of said data processing apparatus and to control storage of said encrypted state.

9. A data processing apparatus according to claim 8, said data processing apparatus further comprising a non-volatile data store, said hibernate state control logic being further operable to control said encryption logic to generate an encryption key during said operational mode, and to control said data processing apparatus to store said encryption key in said non-volatile data store.

10. A data processing apparatus according to claim 1, said data processing apparatus further comprising a non-volatile data store, said non-volatile data store storing an encryption key for use by said encryption logic.

11. A data processing apparatus according to claim 1, said data processing apparatus further comprising a wake signal input and decryption circuitry, said data processing apparatus being responsive to receipt of a wake signal at said wake signal input to switch from said low power mode to said operational mode, said decryption circuitry being operable to decrypt said stored state and to restore said state to said processing circuit.

12. A data processing apparatus according to claim 10, wherein said encryption circuitry and decryption circuitry comprise a single hardware cryptography device.

13. A data processing apparatus according to claim 1, said data processing apparatus further comprising checking logic, said checking logic being operable to derive a checking value from said state, said encryption logic being operable to encrypt said checking value, said checking value being stored in said storage device with said encrypted state.

14. A data processing apparatus according to claim 1, said data processing apparatus further comprising checking logic, said checking logic being operable to derive a checking value from said encrypted state, said checking value being stored in a non volatile memory separate to said storage device storing said encrypted state.

15. A data processing apparatus according to claim 12, said data processing apparatus further comprising a wake signal input and decryption circuitry, said data processing apparatus being responsive to receipt of a wake signal at said wake signal input to switch from said low power mode to said operational mode, said decryption circuitry being operable to decrypt said stored state and to restore said state to said processing circuit, wherein said decryption circuitry is operable to determine an integrity of said decrypted state from said checking value.

16. A data processing apparatus according to claim 1, wherein said data processing apparatus is operable to generate said hibernate signal in response to detection of a predetermined condition.

17. A method of securely saving a state of a processor during hibernation, comprising the steps of:
processing secure data using processing circuitry comprising a plurality of state retention cells for holding a current state of said processing circuitry, at least some of state retention cells being arranged in series;
receiving a hibernate signal at a hibernate signal input;
in response to said hibernate signal switching from an operational mode in which said data processing apparatus is powered up, to a low power mode in which at least said processing circuitry is powered down by:
outputting a state of said processing circuitry from said state retention cells;
encrypting said output state using encryption circuitry;
saving said encrypted state to a storage device; and
powering down said processing circuitry.
